(19) United States
(12) Patent Application Publication
(10) Pub. No.: US 2011/0128906 A1
(43) Pub. Date: Jun. 2, 2011

(54) METHOD AND APPARATUS FOR SELECTIVELY RECEIVING COMMUNICATION

(75) Inventors: Juha Arrasvuori, Tampere (FI); Antti Eronen, Tampere (FI); Hannu Korhonen, Kangasala (FI); Markus Montola, Helsinki (FI)

(73) Assignee: Nokia Corporation, Espoo (FI)

(21) Appl. No.: 12/626,862

(22) Filed: Nov. 27, 2009

(51) Int. Cl. H04W 4/00; H04M 3/42

(52) U.S. Cl. 370/328; 455/414.1

(57) ABSTRACT

An approach is provided for selectively receiving communication from a sender. After the communication platform receives a communication from a user device, the communication platform generates a request for an action to be performed by a user via the user device and transmits the request to the user device. Then, the communication platform receives, from the user device, a response relating to the action, and evaluates the response for treatment of the communication.

### BACKGROUND

Modern communication technologies (e.g., the Internet, wireless communications, etc.) enable users to communicate with great ease, and often at little or no cost. These same properties, however, also make unwanted communications (e.g., unsolicited telephone calls, spam e-mails, unwanted instant messages and other unwanted synchronous communication) more prevalent. These unwanted communications often originate from companies in the form of advertisements, but may sometimes originate from friends and acquaintances as well. In some cases, unwanted communications have increased to such an extent that users may be discouraged from using such communication technologies altogether. Accordingly, communication service providers and manufacturers of communication devices face considerable technical challenges to reducing unwanted communications that reach users.

### SOME EXAMPLE EMBODIMENTS

Therefore, there is a need for an approach for selectively receiving communication from a sender.

According to one embodiment, a method comprises receiving a communication from a user device. The method also comprises generating a request for an action to be performed by a user via the user device. The method further comprises causing, at least in part, transmission of the request to the user device. The method further comprises receiving, from the user device, a response relating to the action. The method further comprises evaluating the response for treatment of the communication.

According to another embodiment, an apparatus comprising at least one processor, and at least one memory including computer program code, the at least one memory and the computer program code configured to, with the at least one processor, cause, at least in part, the apparatus to receive a communication from a user device. The apparatus is also caused to generate a request for an action to be performed by a user via the user device. The apparatus is further caused to transmit the request to the user device. The apparatus is further caused to receive, from the user device, a response relating to the action. The apparatus is further caused to evaluate the response for treatment of the communication.

According to another embodiment, a computer-readable storage medium carrying one or more sequences of one or more instructions which, when executed by one or more processors, cause, at least in part, an apparatus to receive a communication from a user device. The apparatus is also caused to generate a request for an action to be performed by a user via the user device. The apparatus is further caused to transmit the request to the user device. The apparatus is further caused to receive, from the user device, a response relating to the action. The apparatus is further caused to evaluate the response for treatment of the communication.

According to yet another embodiment, an apparatus comprises means for receiving a communication from a user device. The apparatus also comprises means for generating a request for an action to be performed by a user via the user device. The apparatus further comprises means for causing, at least in part, transmission of the request to the user device. The apparatus further comprises means for receiving, from the user device, a response relating to the action. The apparatus further comprises means for evaluating the response for treatment of the communication.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of selectively receiving communication information sent from a user device, according to one embodiment;

FIG. 2 is a diagram of the components of the communication platform, according to one embodiment;

FIG. 3 is a diagram of a process for selectively receiving communication information sent from a user device, according to one embodiment;

FIGS. 4A-4D are flowcharts of a process for evaluating the response, according to various embodiments; and

FIG. 5 is a flowchart of a process for automatically checking, according to one embodiment.

FIG. 6 is a flowchart of a process for automatically checking, according to one embodiment.

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for selectively receiving communication information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

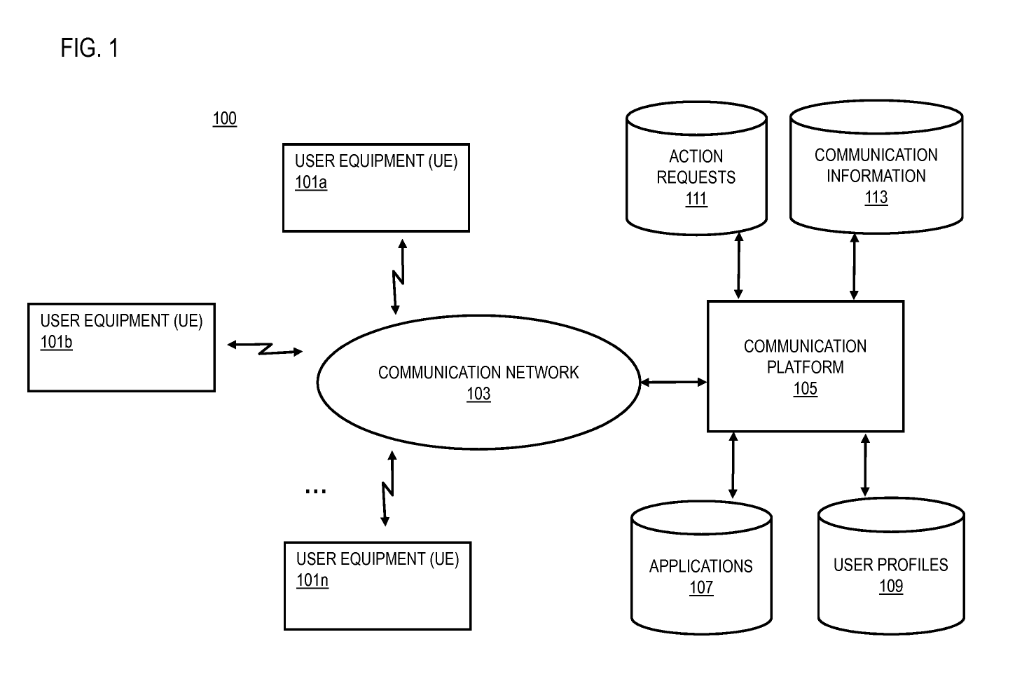

FIG. 1 is a diagram of a system capable of selectively receiving communication information sent from a user device, according to one embodiment. As discussed previously, the development of modern communication technologies has resulted in a growing volume of unwanted communications. It is noted that much of the unwanted communication is sent via telephone systems or the Internet, often as an automated communication. For example, a voice recording can be automatically sent to a communication system user as an advertisement. Further, e-mail communication is a popular and inexpensive form of communication that companies and organizations use for advertisements and other solicitations, which contribute to the overall volume of unwanted spam e-mail messages. In addition, Internet-based communications suggesting information that is unrelated to the user's interest are becoming increasingly common. It is noted that a considerable volume of the e-mail traffic over the Internet is attributable to unwanted or spam e-mail messages, resulting increased network congestion and depletion of resources. Moreover, unwanted communication via telephone or Internet places undue burden on users browsing and sorting through the unwanted communication to find communications of interest. Further, flooding of the unwanted communications may also take up space in an e-mail inbox or a telephone voice mail, thus wasting valuable resources. The flooding of the unwanted communication may also result in deletion or ignoring of wanted communication by a user because the user may mistake the wanted communication as unwanted communication. In addition, unwanted communications can often interrupt people from performing their tasks, and thus may adversely affect productivity of the people performing their respective tasks. For example, while people are performing their tasks, they can be easily distracted by a phone call from a company attempting to communicate unwanted advertisements or an e-mail alert due to a spam mail received. The unwanted communications also adversely affects communication providers and related service providers because the unwanted communications use resources or bandwidth of the communication network. At least for these reasons, there has been a demand for a measure to screen out unwanted communications via regular mail as well as via telephone or Internet.

It is noted that, in certain circumstances, unwanted communications may also originate from friends and acquaintances. For example, one user (e.g., a coworker) may send or forward an e-mail, text message, or other electronic message to a large group of people (e.g., all other workers within a company) with little effort at low or no cost. However, many of the recipients, even though they may be acquainted with or know the sender, may not find such information valuable. Therefore, a user may also face the challenge of finding ways to identify wanted and unwanted communications from friends and block only those messages that are unwanted.

To address this problem, a system 100 of FIG. 1 introduces the capability to selectively receive communication information (e.g., receive communication that is relevant while refusing to receive irrelevant communication information). For example, when a sender's device (e.g., UE 101a) sends communication information to a recipient's device (e.g., UE 101b), a communication platform 105 determines whether the communication information should be received by the recipient. To determine whether to receive the communication information, the communication platform 105 may transmit a challenge (e.g., ask a particular question) or a request to perform a certain action to the sender's device. If the sender's response to the question or the requested action satisfies conditions set in the communication platform 105, then the communication information from the sender (e.g., UE 101a) is allowed to be delivered to the receiving device (e.g., UE 101b). If not, the communication information may be rejected and thus will not be delivered to the recipient. Accordingly, the system 100 provides a method to screen out communication information from a sender based on whether the transmitted challenge conditions (e.g., question, action, etc.) are satisfied. Further, the system 100 deters companies or any other senders from sending unwanted communication such as advertisements because the communication will not be delivered to the recipient unless the sender successfully responds to the question or request for action.

As shown in FIG. 1, the system 100 comprises a user equipment (UE) 101 having connectivity to a communication platform 105, via a communication network 103. By way of example, the communication network 103 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like. Further, in one embodiment, the communication over the communication network 103 may be performed using Hypertext Transfer Protocol (HTTP) or Hypertext Transfer Protocol Secure (HTTPS) protocols.

The UEs 101a-101n are any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.). UE 101 may also be equipped with a microphone or a speaker.

The communication platform 105 may be used as a point of mediation between two or more user devices (e.g., UEs 101a and 101b). The communication platform 105 may be configured so that the communication platform 105 receives communication information from the sending devices via the communication network 103 and then distributes the communication information to corresponding receiving devices via the communication network 103. For example, if the UE 101a wants to communicate with the UE 101b, communication information from the UE 101a passes through the communication platform 105 to reach the UE 101b. The communication platform 105 may be configured to set conditions (e.g., define a challenge question or action) to be satisfied if the communication information from a UE 101a (i.e. sender) is to reach another UE 101b (i.e. recipient).

The communication platform 105 may be connected to databases such as an applications database 107, a user profiles database 109, an action requests database 111 and a communication information database 113. The applications database 107 stores applications or documents or any information that may need to be provided to the sender for the sender to take actions or respond to questions to satisfy conditions set in the communication platform 105. The user profiles database 109 includes information about the users that are on the communication network 103. The user profiles database 109 may include user information that may be used in generating a request for action and/or in forming conditions set in the communication platform 105. The user profiles may have general information about each user, such as the user's network address (e.g., Internet Protocol (IP) address) or telephone number, current status of the user, hobbies and etc. The user profiles may also include user's access history of files (e.g. a listening history of music files). Further, the user profiles may also include user's favorite genres, artists of music, movies, favorite books/book genres, favorite games, favorite web pages and etc. The user's favorites may be automatically derived from user's access history of certain files or software. For example, the most played song can be set as the user's favorite song. The action requests database 111 may include various action requests (e.g., perform an action or respond to a challenge question) that may be sent to the sender of the communication, if selected, such that the sender can attempt to perform the action requested by the communication platform 105. The communication information database 113 is a database used to store any communication information between the users. The communication information database 113 may store the communication information sent from the sender, while the sender attempts to satisfy conditions set by the communication platform 105. The communication information sent form the sender and stored in the communication information database 113 may be deleted if the communication information is sent to a recipient or if the communication is rejected for delivery.

By way of example, the UE 101a and the communication platform 105 communicate with each other and other components of the communication network 103 using well known, new or still developing protocols. In this context, a protocol includes a set of rules defining how the network nodes within the communication network 103 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

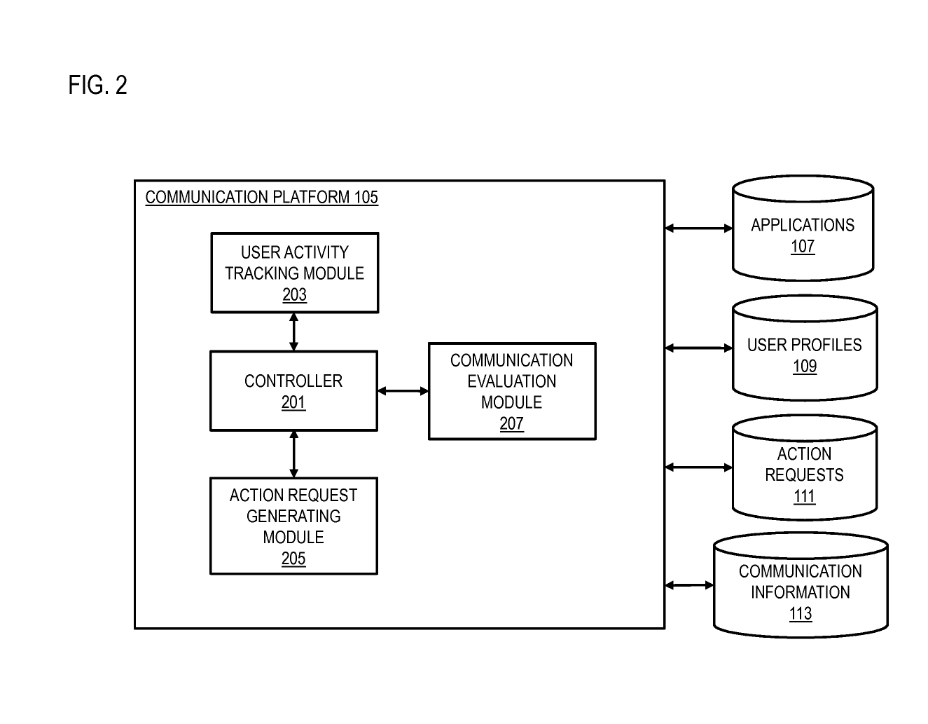

FIG. 2 is a diagram of the components of the communication platform 105, according to one embodiment. By way of example, the communication platform 105 includes one or more components for selectively receiving communication information sent from a user device. It is contemplated that the functions of these components may be combined in one or more components or performed by other components of equivalent functionality. In this embodiment, the communication platform 105 includes a controller 201, a user activity tracking module 203, an action request generating module 205, and a communication evaluation module 207. The controller 201 oversees tasks performed within the communication platform 105 by communicating with the user activity tracking module 203, the action request generating module 205, and the communication evaluation module 207. More specifically, the controller 201 executes at least one algorithm for executing functions of the communication platform 105. The controller 201 also controls communication between the communication platform 105 and other devices. The user activity tracking module 203 tracks actions by each user, and may store a history of user activity in a database as a future reference. For example, the user activity tracking module 203 may keep a record of the number of times that a sender was successful in responding to the request for an action to satisfy conditions set by the communication platform 105. The action request generating module 205 generates a request for a sender's action and sets the conditions that needs to be satisfied by the sender's action to allow the sender's communication to the recipient. When the sender responds with an action in response to the request, the communication evaluation module 207 evaluates to determine whether the sender's action satisfies the conditions set in the communication platform 105. Further, the communication platform 105 is connected to databases such as the applications database 107, the user profiles database 109, the action requests database 111 and the communication information database 113, such that the communication platform 105 can store information in the databases or access information stored in the databases.

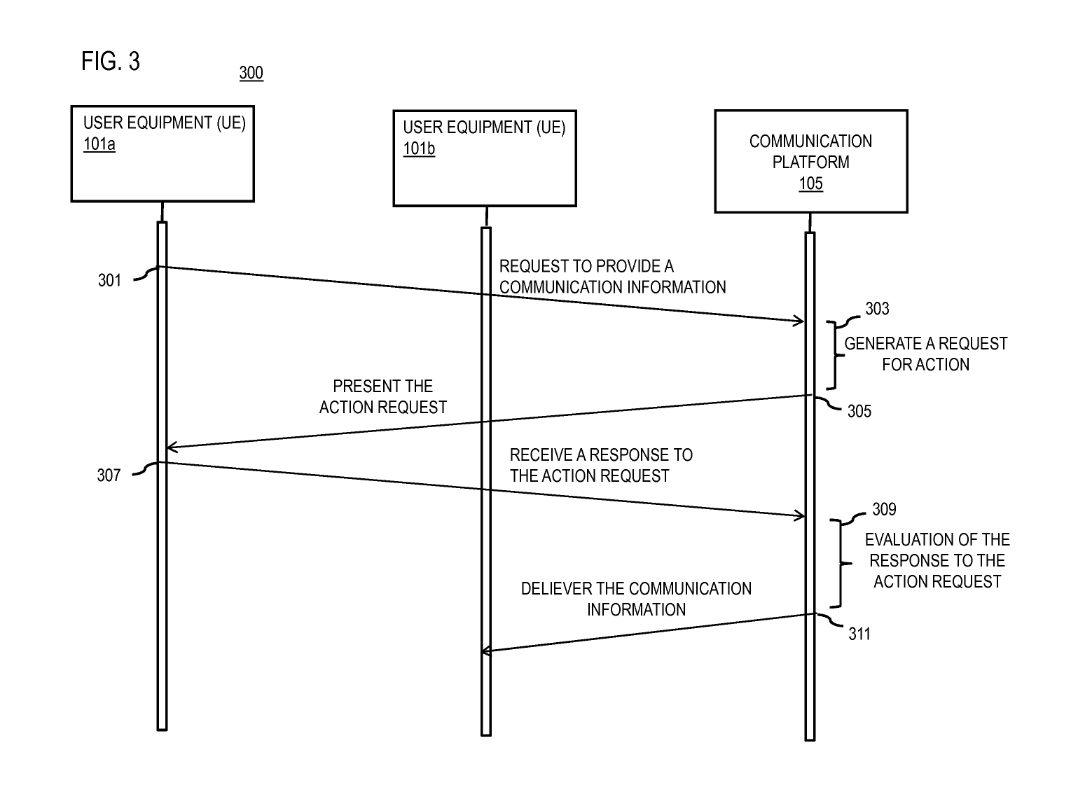

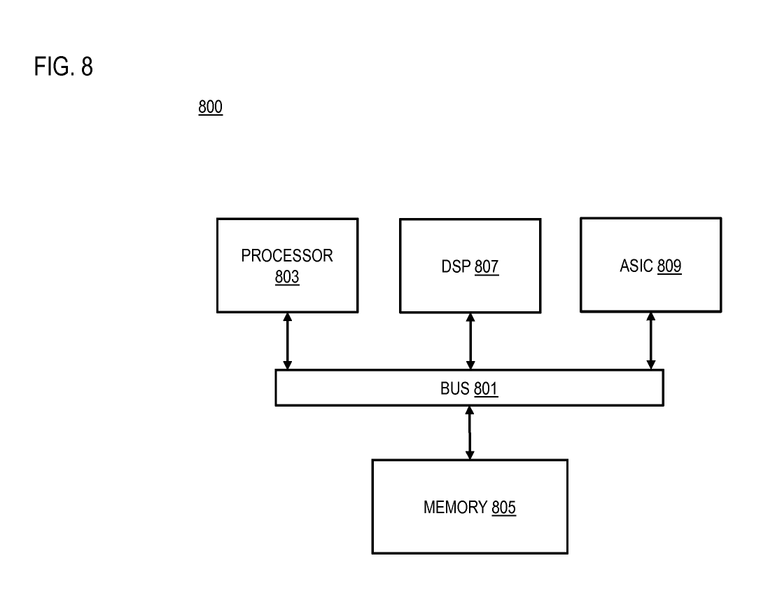

FIG. 3 is a flowchart of a process for selectively receiving communication information sent from a user device, according to one embodiment. In one embodiment, the communication platform 105 performs the process 300 and is implemented in, for instance, a chip set including a processor and a memory as shown FIG. 8. In step 301, as a sender's device (e.g. UE 101a) attempts to provide communication information to a recipient's device (e.g. UE 101b), the request to provide the communication information is sent to the communication platform 105. The communication information from the sender may be in many different forms. For example, the communication information may be in a form of telephone call or an electronic message (e.g. e-mail or text message). As another example, the communication information may be recommendations that a sender suggests to the recipient, such as recommendations on music, books, movies, restaurants, jobs, events and etc. Upon receipt of such communication from the sender's device, the communication platform 105 generates a request for an action to be performed by the sender's device, as shown in step 303. Next, in step 305, a request for action is sent to the sender's device and waits for the sender to respond to the request. The communication platform 105 does not deliver or allow the communication information to be sent to the recipient's device until the response to the request for action sent from the sender's device satisfies conditions set in the communication platform 105. Thus, the sender may perform the action as a response to the request for action, and send such response to the communication platform 105 for evaluation.

The sender may also decide not to respond to the request for action, in which case the sender's communication will not be sent to the recipient's device. For example, the sender may cancel the communication if the sender does not want to respond to the request for action. The sender may also decide to respond to the request for action at a later time due to various reasons such as the sender being occupied with other tasks or the request for action being too difficult to answer within a short period of time. Thus, alternatively, instead of deleting or ignoring the sender's communication, the delivery of the sender's communication may be delayed for a predetermined period of time (e.g. an on-hold time) while waiting for the sender to respond if the sender does not immediately respond to the request for action. In one embodiment, the user may set the on-hold time. In addition or alternatively, the service provider, network operator, or the like may determine the time determined for the sender to respond. Thus, if the sender does not respond within the on-hold time, the sender's communication is deleted or ignored. After receiving the response from the sender' device (step 307), the communication platform 105 in step 309 evaluates the response to the request for action in order to determine whether the response satisfies the condition set for the recipient. If the communication platform 105 determines that the response to the request for action satisfies the condition, then the communication platform 105 allows delivery of the communication information to the recipient's device, as shown in step 311.

The request for action to be sent to the sender may be in many different forms. As one example, the request may be in a form of a question for which a sender needs to provide an answer. The question may be in a multiple choice format or may ask the sender to enter a text as an answer. Various topics may be used in the question. For example, the question may be about information related to the recipient. The question about the recipient may be related to any random information such as the number of siblings that the recipient has. Then, one purpose of this question may be to ensure that the sender knows the recipient well enough to earn the trust that the communication information from the sender is not unwanted. Further, a user (i.e. prospective recipient) may customize the user profile to update the status, and the questions may be based on the user profile. For example, if the user profile is set to show that the user is working on Project A, a question related to Project A would be sent to the sender as a request for action. If the sender is not involved with Project A, the sender is not likely to be able to answer the question, and thus the sender's communication may not be received by the recipient's device. This allows the user to screen out communication from a sender who is not related to Project A, so that the user will not be unnecessarily distracted while working on Project A. As another example, if the user profile is set to show that the user is on vacation, a question about the user's personal life may be sent to the sender such that, if the sender is a co-worker who does not know the user's personal life, the sender would not be able to bother the user with communication while the user is on vacation.

In addition, the request for action may ask to the sender to complete all or part of a task that the recipient is performing when the sender attempts to send the communication. For example, the recipient may be too busy with a task to pay attention to the sender's communication. Then, the recipient may send the request for action asking the sender to complete a part of the task so that the recipient can complete the task faster and then look at the sender's communication. The task may include a work-related activity or a game that requires completing various sub-tasks, and the request for action may be configured such that the sender would complete some or all of these sub-tasks. For example, if the recipient is playing a video game of killing monsters as a task and the sender is attempting to communicate with the recipient, the recipient sends the sender a request for action to complete a sub-task, such as killing some of the monsters in the recipient's video game. With the help of the sender, the recipient may finish killing the monsters faster and then get to the communication from the sender.

If the communication information is related to recommendations by the sender, then the questions may be formed to evaluate relevancy of the recommendations. The purpose of the question may be to screen out recommendations that may be unwanted by the recipient due to various reasons including irrelevancy or randomness of the recommendations. For example, if the communication information is recommendation on a song, the question may ask what kind of music the recipient likes the most. Then, the purpose of this question is to ensure that the sender knows the recipient's taste in music well enough to make recommendations. If the communication information is recommendation on media, the question may be related to the media being recommended. For example, if an action movie is recommended, the question may ask who the main character of the action movie is. As another example, if a Jazz music is recommended, the question may ask to list at least two sub-genres of Jazz. One purpose of this type of questions may be to ensure that the sender has sufficient knowledge about the media and is thus qualified to make recommendations to the recipient. The question may also include media as a part of the question, where a sound clip or a video clip is played as a form of question. For example, a sound clip may be played and the request for action may ask the sender to identify the title of the song to which the sound clip belongs.

The request for action may also be in a form to ask the sender to perform a certain task to a sufficient level. For example, as a request for action, the sender may be asked to sing a portion of a song, and then the sender's performance may be evaluated to see if the sender performed at a sufficient level. In this example, the sender may need to satisfy a predetermined threshold, such as a predetermined percentage of correct tunes in the sender's singing, in order to be able to send communication to the recipient. As another example of a request for action, the sender may be asked to solve a puzzle or play a game, and the sender's communication information will be delivered to the recipient only if the sender performs at a sufficient level.

The request for action may be automatically generated based on available information, such as information on databases. For example, the request for action may be automatically generated based on the profile of the recipient, to form questions about the recipient. As another example, the request for action may be automatically generated based on the media information, wherein, for example, information about an album of an artist from the genre of the media being recommended can be retrieved from a database, such as media catalog, and a question about such information may be automatically generated. Alternatively, the request for action may be generated manually, possibly including an option for a recipient to customize the request. In one example, a user (i.e. prospective recipient) may use a pre-existing template for a request for action and customize parameters for the template to set the request for action. For example, if the request for action is a customizable question, wherein the question is “what is the user's favorite <artist/genre/album/track> in music?” the user may set the parameter <artist/genre/album/track> to choose among artist, genre, album and track. Alternatively, the user may set the parameter <artist/genre/album/track> as random such that a parameter is randomly selected among artist, genre, album and track.

There may be a concern that some senders may not want to spend time responding to the request for action. Therefore, in order to provide a sender with additional incentives to respond to the request for action, the sender may be rewarded in various ways. For example, the sender may collect a certain number of points every time the sender responds to the request for action, and the sender may collect even more points for every successful response to the request for action. Then, these points may be used to make purchase on line. As another example, for every successful response to the request for action, a user may be given a chance to win prizes, in a lottery format. As another example, for every successful response to the request for action, the user may be provided with a predetermined number of “free passes” that allow the user to send a communication to a recipient without having to respond to the request for action. These “free passes” may be set such that they can be used for only certain types of request for action. Various other methods may be included to encourage senders to respond to the request for action.

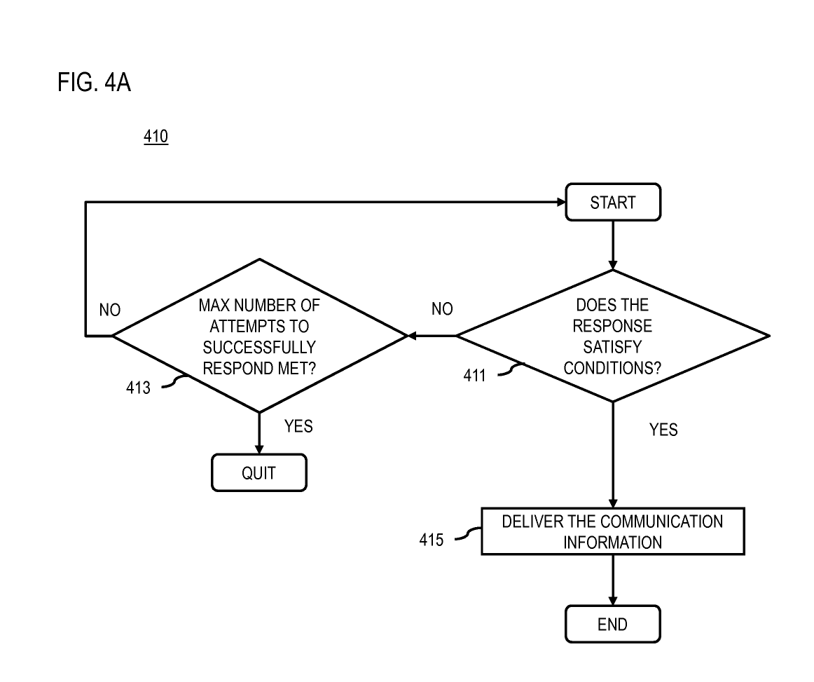

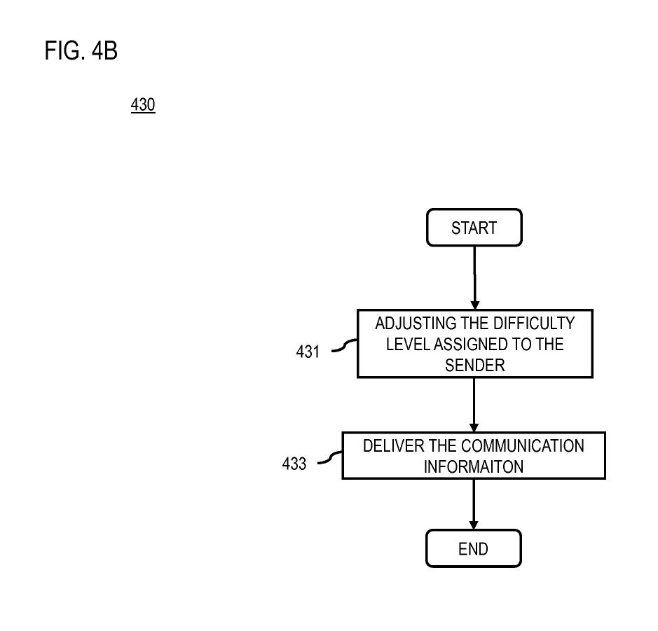

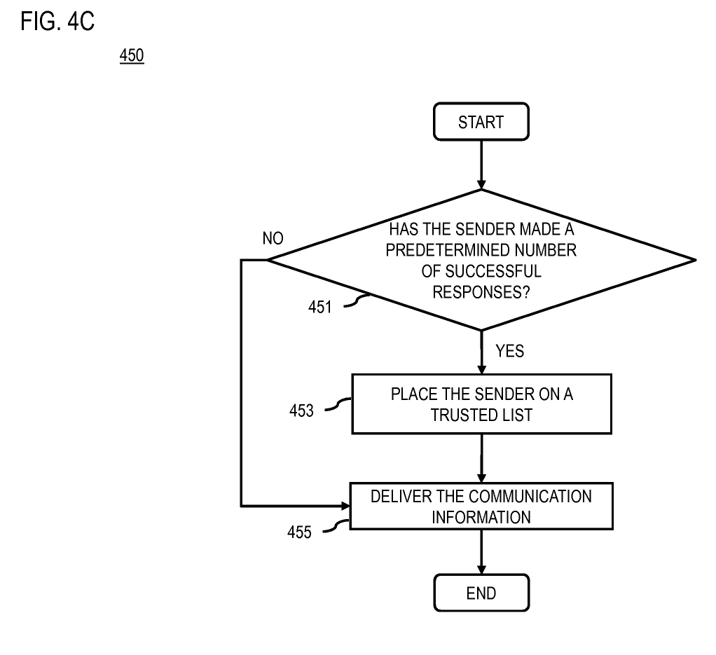

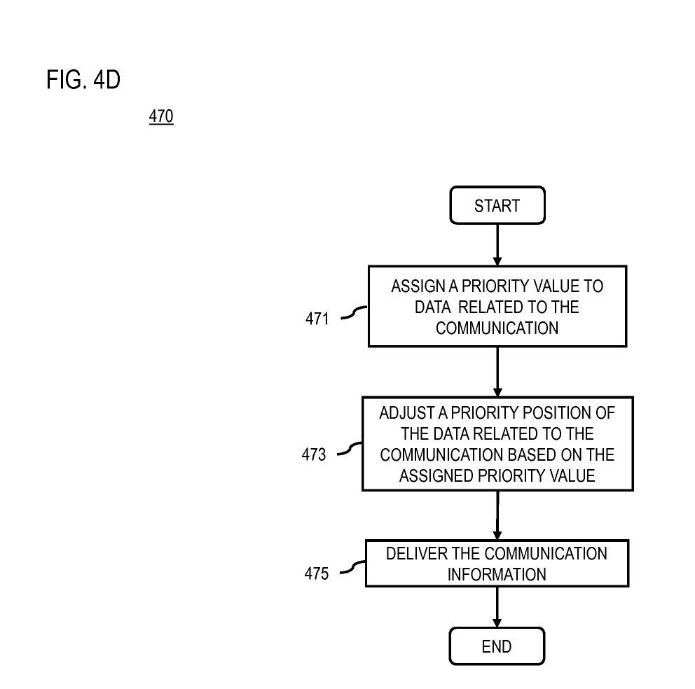

FIGS. 4A-4D are flowcharts of processes for evaluating a response to an action request, according to various embodiments. FIG. 4A depicts a process for delivering a communication after satisfying the action request. FIGS. 4B-4D depict additional embodiments of processes that the communication platform 105 may perform following satisfaction of an action request as described with respect to FIG. 4A. In particular, FIG. 4B depicts a process for adjusting the difficulty of an action request, FIG. 4C depicts a process for placing the sender on a trusted senders list, and FIG. 4D depicts a process for prioritizing communication information based on response to the action request.

According to one embodiment shown in FIG. 4A, in step 411, the communication platform 105 evaluates the sender's response to the request for action, to determine whether the sender's response satisfies the conditions set in the communication platform 105. If the response satisfies the conditions, the communication from the sender is allowed to be delivered to the recipient's device, as shown in step 415. If the response does not satisfy the conditions, then the communication platform 105 may provide the sender with another chance to respond successfully. However, each time the sender unsuccessfully responds to the request for action, the number of unsuccessful attempts for the request for action may be kept in a record. Then, as shown in step 413, if the number of sender's attempts to respond to the request for action reaches the maximum number of attempts allowed for the request for action, the communication platform 105 rejects the communication from the sender. On the contrary, as shown in step 413, if the number of sender's attempts to respond successfully has not reached the maximum number of attempts allowed, then the sender is provided with another opportunity to respond successfully to the request for action.

According to another embodiment shown in FIG. 4B, the communication platform 105 may alternately or additionally perform the process 430 if the sender has responded successfully to the action request according to the process of step 411 of FIG. 4A. In step 431, the communication platform 105 adjusts the difficulty level assigned to the sender. For example, if the sender responds successfully, the difficulty level of the future requests for action that will be given to the sender may be increased, in order to make a request that is more difficult to respond. Thus, in one example, if the sender successfully answers a question about a basic knowledge about Jazz music, then the future question will be about more in-depth knowledge in music. One purpose of the increased difficulty may be to challenge the sender more with more difficult requests. Alternatively, the difficulty level of the future action requests may be decreased if the sender responds successfully, in order to reward the sender for a successful response. Further, different difficulty levels may be assigned to the sender depending on the type of the request for action. For example, a high difficulty level may be assigned for a request for action generated based on the recipient's profile while a low difficulty level may be assigned for a request for action generated based on music. Then, the communication from the sender is allowed to be delivered to the recipient's device, as shown in step 433. Furthermore, the recipient may set the difficulty level of the request for action based on various reasons, such as the recipient's need for privacy. For example, if the recipient does not want to be bothered, the recipient may set the difficulty level high, for some senders or all senders. In addition, there may be a process in step 303 of FIG. 3 to check a difficulty level assigned to the sender, in order to generate the request for action in accordance with the difficulty level.

According to another embodiment shown in FIG. 4C, the communication platform 105 may alternately or additionally perform the process 450 if the sender has successfully responded to the action request according to the process of step 411 of FIG. 4A. In step 451, the number of the sender's successful responses is increased by one, and it is determined whether the sender has made a predetermined number of successful responses. If the sender has not made the predetermined number of successful responses, the communication from the sender is allowed to be delivered to the recipient's device as shown in step 455, without placing the sender on a trusted list. On the contrary, if the sender has made the predetermined number of successful responses, then the sender may be placed on a trusted list, as shown in step 453 and then the communication from the sender is allowed to be delivered to the recipient's device, as shown in step 455. Alternatively, the sender may be placed on a trusted list if the sender has reached a minimum predetermined rate of successful responses, after responding to a minimum number of requests for action. For example, if the minimum rate of successful response is 70% and the minimum number of requests for action to respond is set to ten, the sender may be placed on a trusted list if the sender has responded to at least ten requests for action, and has successfully responded to at least 70% of the requests that the sender responded. The users on the trusted list are not required to respond to the action request. One reason for this implementation is because the sender who has made sufficient number of successful responses earns the recipient's trust and thus does not need to be validated by the successful response. A procedure to check whether the sender is on the trusted list may be implemented before generating the action request in step 303. Then, the sender's communication can be delivered directly to the recipient's device if the sender is on the trusted list. Furthermore, the trusted list may be organized by categories. For example, a sender may be placed on a trusted list for sending music recommendations but may not be placed on a trusted list for sending office documents, depending on the user's successful response on the respective categories.

In another embodiment, in addition or as an alternative to the trusted list, each user on the communication network 103 may be assigned a hierarchy level. Depending on the hierarchy level, one user is asked to respond to a request for action from another user. For example, if the sender of the communication has a higher hierarchy level than the recipient, the sender may send communication to the recipient without responding to the request for action. However, if the sender of the communication has a lower hierarchy level than the recipient, the sender has to respond to the request for action to deliver the sender's communication to the recipient. The hierarchy level may be assigned to the users based on various conditions. For example, a president of the company may have the highest hierarchy level, and a secretary have a lower hierarchy level, such that the president may communicate to the secretary without responding to the request for action, but the secretary must respond to the request for action to communicate to the president. As another example, in an on-line video game guild, a leader of the guild may have the higher hierarchy level than any other members of the guild.

According to another embodiment shown in FIG. 4D, the communication platform 105 may alternately or additionally perform the process 470 if the sender has successfully responded to the action request according to the process of step 411 of FIG. 4A. In step 471, a priority value is assigned to a data related to the sender's communication. For example, because the sender successfully responds to the action request, the data related to the sender's communication may be given a high priority value. Further, the priority value may be weighted depending on the difficulty of the action request. For example, if the difficulty level of a request for action is high, then, upon a successful response by the sender, a high priority value may be given to the data related to the sender's communication because the sender passed a difficult validation process. On the contrary, if the request for action belongs to an easy level, lower priority value may be given to the data related to the sender's communication. After the priority value is assigned, the priority position of the data related to the sender's communication is adjusted based on the priority value of the data, as shown in step 473. For example, a music file recommended by the sender may be assigned a priority value, and the position of the music file on a recipient's music playlist may be adjusted based on this priority value (e.g. a music file with high priority value is listed on top and a music file with low priority value is listed on the bottom). In addition, the priority value may be adjusted based on the sender's rate of successful response to the request for action. For example, if sender A has successfully responded to eight requests for action out of ten requests for action and sender B has successfully responded to two requests for action out of ten requests for action, then sender A's communication information may be assigned a higher priority value than sender B's communication information. Then, the communication from the sender is allowed to be delivered to the recipient's device, as shown in step 475.

The priority value may be used to sort and/or categorize the sender's communication. For example, in a case of a phone call from a sender, a phone call with high priority may be delivered to the recipient directly, a phone call with medium priority may be delivered to the recipient's secretary, and a phone call with low priority may be delivered to a voice mail. As another example, an e-mail with high priority may be delivered to a high-priority folder, whereas an-email with medium and low priorities may be delivered to a regular folder and a low-priority folder, respectively. In addition, the priority value may be used to define forms of alerting the recipient of the sender's communication. For example, a loud sound may ring as an alert if the sender's communication with high priority value is received, whereas a quiet sound may ring if the sender's communication with low priority value is received. As another example, the sender's communication with high, medium and low priority values may define the alerts as visual alarm with sound, sound, and vibration, respectively.

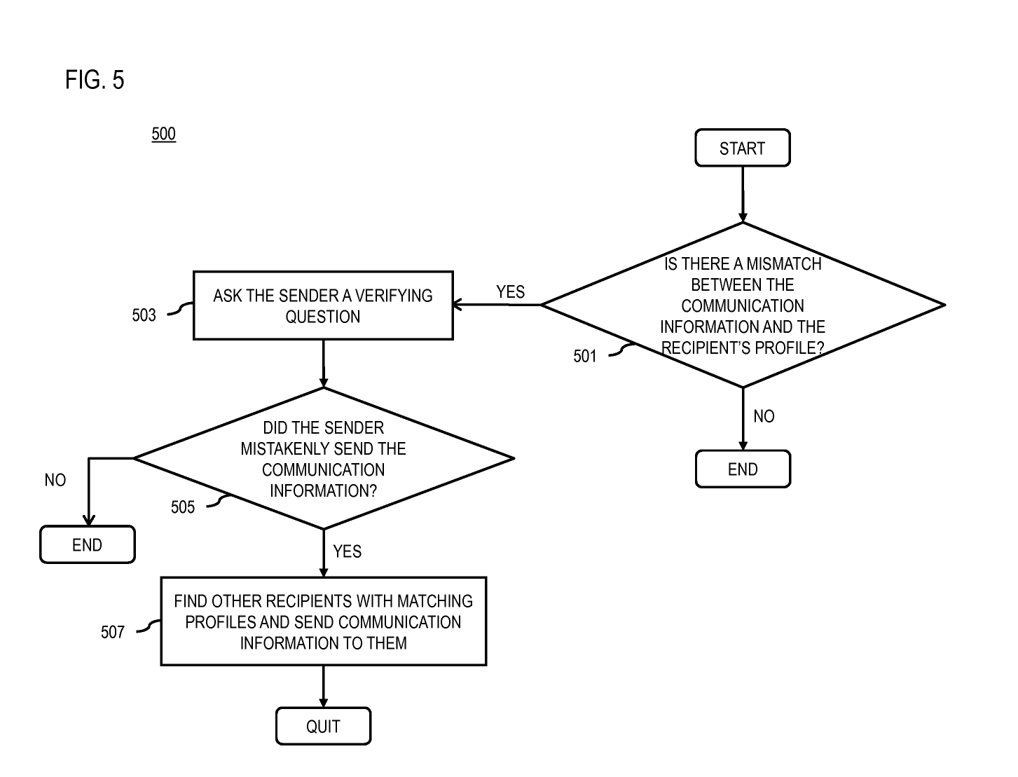

FIG. 5 is a flowchart of a process utilized in step 301 of FIG. 3, according to one embodiment. As shown in FIG. 5, when a sender attempts to send communication information to a recipient, the communication platform 105 checks whether there is a mismatch between the communication and any information about the recipient such as the recipient's profile, as shown in step 501. If there is no mismatch, then the communication platform 105 proceeds to the next step in the communication. If there is a mismatch, then the communication platform 105 asks the sender a verifying question in step 503, to determine whether the sender has mistakenly sent the communication information to the recipient, as shown in step 505. Based on the sender's response to the question, if it is decided that the sender has not mistakenly sent the communication information to the recipient, then the communication platform 105 proceeds to the next step in the communication. On the contrary, if it is decided that the sender has mistakenly sent the communication information, then the communication platform 105 may rejection the sender's communication information. Additionally, as shown in step 507, before rejecting the sender's communication information, the communication platform 105 may try to find other users with matching profiles and send the communication information to their user devices.

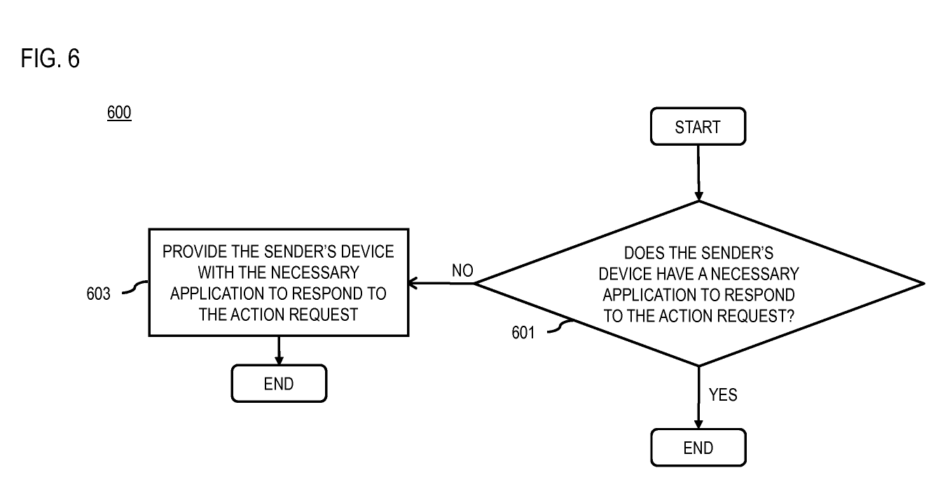

FIG. 6 is a flowchart of a process utilized in step 305 of FIG. 3, according to one embodiment. If the communication platform 105 sends an action request to the sender of the communication information, the sender may not have a necessary application to be able to respond to the action request. Thus, step 601 checks whether the sender's device has a necessary application to respond to the action request. If the sender has the necessary application, the communication platform 105 waits for the sender to respond. On the contrary, if the sender does not have the necessary application, then the communication platform 105 provides the sender's device with the application, as shown in step 603, so that the sender can use the application to respond to the action request. For example, if the request for action asks the sender to finish a puzzle game and if the sender does not have a puzzle game, then the sender will be provided with the puzzle game. As another example, if the request for action asks the sender to fill out a job application and the sender does not have the job application, the sender is provided with the job application. In this step, to provide the application to the sender's device, the communication platform 105 may access the application stored in the applications database 107. In addition, if the sender is requested to complete a part or all of a task such as work-related activity, then any applications or documents that may be necessary to complete such task is provided to the sender. As mentioned above, in a video game, if the sender is requested to kill one of the monsters or complete one of the levels in the video game, then some or all portions of the video game that the sender needs to complete such sub-tasks are provided to the sender.

The processes described herein for selectively receiving communication from a sender may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

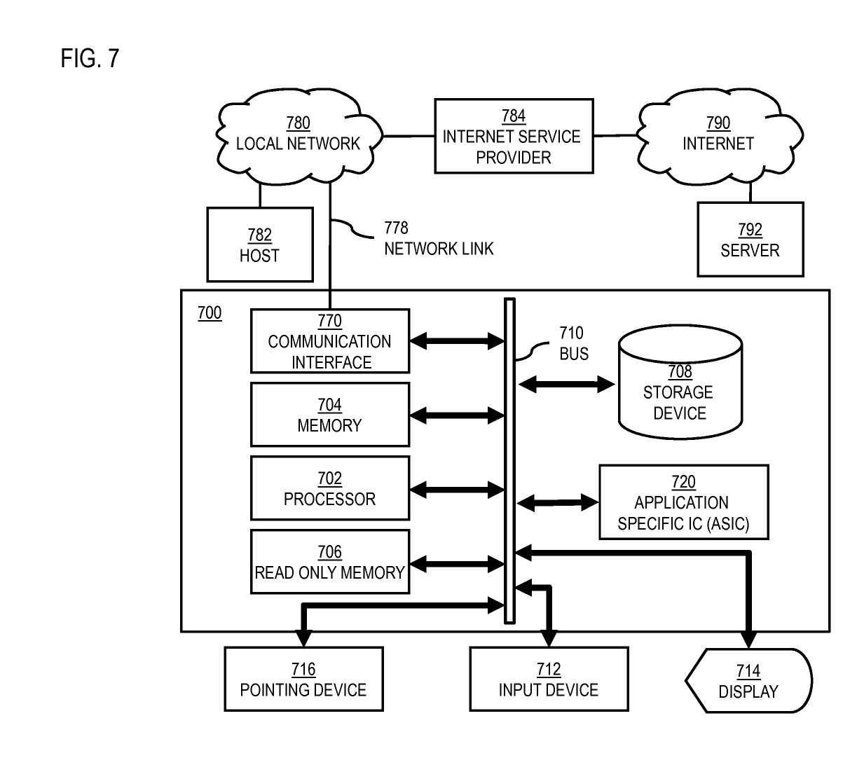

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to selectively receive communication from a sender as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of selectively receiving communication from a sender.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to selectively receiving communication from a sender. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for selectively receiving communication from a sender. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for selectively receiving communication from a sender, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 103 for selectively receiving communication from a sender.

The term “computer-readable medium” as used herein to refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set 800 upon which an embodiment of the invention may be implemented. Chip set 800 is programmed to selectively receive communication from a sender as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 800, or a portion thereof, constitutes a means for performing one or more steps of selectively receiving communication from a sender.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to selectively receive communication from a sender. The memory 805 also stores the data associated with or generated by the execution of the inventive steps.

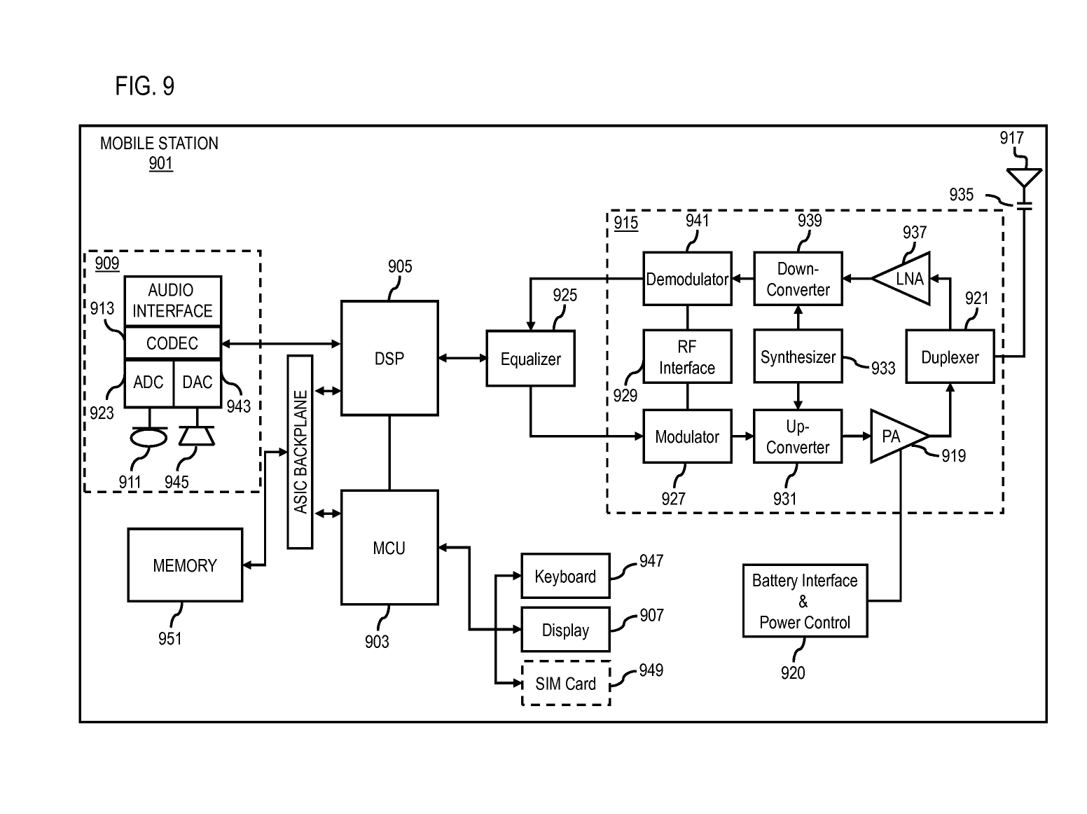

FIG. 9 is a diagram of exemplary components of a mobile terminal (e.g., handset) for communications, which is capable of operating in the system of FIG. 1, according to one embodiment. In some embodiments, mobile terminal 900, or a portion thereof, constitutes a means for performing one or more steps of selectively receiving communication from a sender. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of selectively receiving communication from a sender. The display 9 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to selectively receive communication from a sender. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a communication from a user device;
generating a request for an action to be performed by a user via the user device;
causing, at least in part, transmission of the request to the user device;
receiving, from the user device, a response relating to the action; and
evaluating the response for treatment of the communication.

2. The method of claim 1, wherein the communication provides recommendation information by the user.

3. The method of claim 1, wherein the step of generating a request for action includes generating a question to be answered by the user.

4. The method of claim 3, wherein the question is generated based on either a profile of a recipient or the communication from the user device.

5. The method of claim 1, wherein the request for action includes either a request for musical performance to be performed by the user or a request to perform a task on the user device.

6. The method of claim 1, wherein the evaluating includes:
determining whether the response relating to the action satisfies a predetermined condition.

7. The method of claim 6, further comprising:
adjusting a difficulty level of the request assigned to the user if the response relating to the action satisfies the predetermined condition.

8. The method of claim 6, further comprising:
placing the user on a trusted list, if the user made a predetermined number of responses that satisfy the predetermined condition,
wherein a communication information from a user on the trusted list is delivered to a recipient's device without the user responding to a request for an action.

9. An apparatus comprising:
at least one processor; and
at least one memory including computer program code,
the at least one memory and the computer program code configured to, with the at least one processor, cause the apparatus to perform at least the following,
receive a communication from a user device;
generate a request for an action to be performed by a user via the user device;
cause, at least in part, transmission of the request to the user device;
receive, from the user device, a response relating to the action; and
evaluate the response for treatment of the communication.

10. The apparatus of claim 9, wherein the communication provides recommendation information by the user.

11. The apparatus of claim 9, wherein the generated request for action includes a question to be answered by the user

12. The apparatus of claim 11, wherein the question is generated based on either a profile of a recipient or the communication from the user device.

13. The apparatus of claim 9, wherein the request for action includes either a request for musical performance to be performed by the user or a request to perform a task on the user device.

14. The apparatus of claim 9, wherein the response is evaluated by determining whether the response relating to the action satisfies a predetermined condition.

15. The apparatus of claim 14, wherein the computer program code configured to further cause the apparatus to adjust a difficulty level of the request assigned to the user if the response relating to the action satisfies the predetermined condition.

16. The apparatus of claim 14, wherein the computer program code configured to further cause the apparatus to place the user on a trusted list, if the user made a predetermined number of responses that satisfy the predetermined condition, and
wherein a communication information from a user on the trusted list is delivered to a recipient's device without the user responding to a request for an action.

17. A computer-readable storage medium carrying one or more sequences of one or more instructions which, when executed by one or more processors, cause an apparatus to at least perform the following steps:
receiving a communication from a user device;
generating a request for an action to be performed by a user via the user device;
causing, at least in part, transmission of the request to the user device;
receiving, from the user device, a response relating to the action; and
evaluating the response for treatment of the communication.

18. The computer-readable storage medium of claim 17, wherein the step of generating a request for action includes generating a question to be answered by the user

19. The computer-readable storage medium of claim 17, wherein the evaluating includes:
determining whether the response relating to the action satisfies a predetermined condition.

20. The computer-readable storage medium of claim 17, the computer-readable storage medium further causing the apparatus to place the user on a trusted list, if the user made a predetermined number of responses that satisfy the predetermined condition,
wherein a communication information from a user on the trusted list is delivered to a recipient's device without the user responding to a request for an action.
